(19) United States
(12) Patent Application Publication
(10) Pub. No.: US 2017/0051551 A1
(43) Pub. Date: Feb. 23, 2017

(54) A SYSTEM FOR OPENING AND CLOSING A WINDOW

(71) Applicant: Sonrex Group Limited, London (GB)

(72) Inventor: Richard Anthony Harwood Smart, London (GB)

(73) Assignee: Sonrex Group Limited, London (GB)

(21) Appl. No.: 15/307,553

(22) PCT Filed: May 21, 2015
(86) PCT No.: PCT/GB2015/051485

§ 371 Date: Oct. 28, 2016

(30) Foreign Application Priority Data
May 21, 2014 (GB) 1408983.3
Jun. 23, 2014 (GB) 1410583.7
Oct. 10, 2014 (GB) 1417936.0

(51) Int. Cl. E05F 15/71; E05D 15/22; G08G 5/00; E05F 1/02; E05F 15/72; E05F 15/73; E05D 13/00; E05F 15/60

(52) U.S. Cl. CPC E05F 15/71; E05D 13/14; E05D 15/22; E05F 15/60; E05F 1/025; E05F 15/72; E05F 15/73; G08G 5/0082; E05Y 2900/148

(57) ABSTRACT

The invention relates to a system for opening and closing a window aperture, the system comprising: a moveable window panel; a pulley assembly coupled to the moveable window panel; a counterweight; and a pulley actuation mechanism. The moveable panel is heavier than the counterweight, the latter being attached to a first lateral side of the moveable panel via a first part of the pulley assembly. The pulley actuation mechanism is attached to an opposite lateral side of the moveable panel via a second part of the pulley assembly. The pulley actuation mechanism is switchable between energised and non-energised states based on one or more trigger events, between a closing mode whereby the pulley actuation mechanism retracts the second part of the pulley assembly thus imparting an additional closing force to the moveable panel sufficient to raise the moveable panel; and an opening mode whereby the pulley actuation mechanism is non-energised such that a passive opening force is imparted to the moveable panel by virtue of its weight to lower the moveable panel. A system for controlling a window system based on aircraft detection is also disclosed.

The present invention relates to a system for opening and closing a window, particularly, but not exclusively, windows such as those commonly found in domestic premises.

In areas where noise pollution can be a problem it is common for double or triple glazing windows to be installed. This can be achieved by installing modern, fully fitted double glazing windows which are often of the “pivot and tilt” variety. However, in many properties it is either impossible to install such windows (due to e.g. planning or building regulations etc.) or is simply undesirable to do so (for aesthetic reasons etc.). For this reason, vertical or horizontal reciprocating windows remain common.

It is possible to install such reciprocating windows with double or triple glazing panes; however, this can make the windows prohibitively heavy to operate by hand.

Another problem is that of noise pollution. For instance, an occupant of a building with such reciprocating windows may wish to leave their window slightly open (or “ajar”) in warm summer evenings during quiet periods whilst ensuring that the window remains closed during noisy periods. A particular example of when this may be useful is in busy urban environments where noise from e.g. traffic and aircraft passing overhead can increase dramatically at relatively predictable times throughout the day.

According to a first aspect of the present invention there is provided a system for opening and closing a window aperture, the system comprising:
a moveable window panel;
a pulley assembly coupled to the moveable window panel;
a counterweight; and
a pulley actuation mechanism;
   wherein the moveable panel is heavier than the counterweight; the counterweight being attached to a first lateral side of the moveable panel via a first part of the pulley assembly to impart a first continuous closing force thereto; and the pulley actuation mechanism being attached to an opposite lateral side of the moveable panel via a second part of the pulley assembly; and wherein the pulley actuation mechanism is switchable between energised and non-energised states based on one or more trigger events, between:
a closing mode in which the pulley actuation mechanism retracts the second part of the pulley assembly thus imparting an additional closing force to the moveable panel sufficient to raise the moveable panel; and
an opening mode in which the pulley actuation mechanism is non-energised such that a passive opening force is imparted to the moveable panel by virtue of its weight to lower the moveable panel.

It will be appreciated that this arrangement essentially replaces one of two counterweights in a conventional sash and case window system with a pulley actuation mechanism. The first continuous closing force imparted to the moveable window panel by the counterweight is insufficient by itself to actually raise the panel to a closed position.

Optionally, the first part of the pulley assembly comprises a first pulley cord, a first end of which is attached to a first lateral side of the moveable panel at a point remote from its uppermost edge; the pulley cord extending around a first pulley wheel; and an opposite end thereof being connected to the counterweight.

Optionally, the second part of the pulley assembly comprises a second pulley cord, a first end of which is attached to a second lateral side of the moveable panel at a point remote from its uppermost edge; the pulley cord extending around a second pulley wheel; and an opposite end thereof being connected to the pulley actuation mechanism.

By providing the counterweight and pulley actuation mechanism at opposing lateral sides of the moveable window panel serves to balance the opening and closing movement and so resists jamming.

Optionally, the pulley actuation mechanism is retro-fittable into a pre-existing window system and adapted to cooperate with pre-existing first and second pulley cords and pulley wheels.

Optionally, the pulley assembly additionally comprises a third part comprising a third pulley cord, a first end of which is attached to the first lateral side of the moveable panel proximate its uppermost edge; the third pulley cord extending around third and fourth pulley wheels; and an opposite end thereof being connected to the pulley actuation mechanism.

It will be appreciated that this arrangement improves the balance of the opening and closing movement by equalising the opening force imparted to the moveable window panel. Since the second and third pulley cords are connected to a common pulley actuation mechanism, and connected to the window panel at substantially equal lateral distances about central vertical axis thereof, substantially equal opening forces are applied to opposing lateral sides of the window panel.

Optionally, the third and fourth pulley wheels are located within the upper window lintel.

Optionally, the second pulley wheel is a double pulley wheel that is substantially vertically aligned with the fourth pulley wheel.

Optionally, the vertical spacing between the second and fourth pulley wheels is at least 350 mm, and no less than the opening stroke of the moveable panel.

It will be appreciated that such a spacing ensures that no part of the first or second pulley wheels or first and second pulley cords are visible when the moveable window panel is in an open state.

Optionally, the pulley actuation mechanism comprises a bi-directional screw thread mechanism for actively retracting, and passively releasing, lengths of pulley cord to raise and lower the moveable window panel.

An electrically powered bi-directional screw mechanism may be rotatable in one direction, e.g. clockwise, to retract the second (and third) pulley cords away from the pulley wheels thus imparting the closing force; and in the opposite direction, e.g. counter-clockwise, to permit opening. The pulley cords may be connected to the screw mechanism by means of an anti-rotation bearing to prevent twisting during rotation of the screw mechanism.

Optionally, the first and second pulley wheels are located within opposing side window casings.

Optionally, the system further comprises a timer mechanism wherein said one or more trigger events are based on predetermined time(s) as calculated by the timer mechanism.

Optionally, the timer mechanism is adapted to retain a schedule of predetermined user-inputted timings based on a day, week, month and/or year schedule.

Optionally, the system further comprises a sensor, wherein one or more trigger events are based on a variable detected by the sensor.

It will be appreciated that, rather than incorporate physical sensors into the apparatus or system of the present invention, data from third party sensors may be communicated to the system via the cloud/internet using an appropriate application program interface (API) and used to trigger opening and closing protocols.

Optionally, the sensor comprises a sound meter and the variable is a detected external noise level above or below predetermined threshold levels.

A sound meter may be provided locally, or the external noise level may be indirectly deduced or predicted by, for example, local traffic congestion or train scheduling information obtained from third party sources accessed via the cloud/internet.

Optionally, the sensor comprises a thermometer and a variable is a detected internal and/or external air temperature above or below predetermined threshold levels.

A thermometer may be provided locally, or the temperature level (and indeed general weather conditions) may be indirectly deduced or predicted by, for example, local weather information obtained from a third party source accessed via the cloud/internet.

Optionally, the sensor comprises a smoke detector and a variable is a detected smoke level above or below predetermined threshold levels.

Optionally, the sensor comprises a pollen detector and a variable is a detected external pollen count above or below predetermined threshold levels.

Pollen levels may be provided locally, or may be indirectly deduced or predicted by, for example, information obtained from a third party source accessed via the cloud/internet.

Optionally, the sensor comprises an air quality detector and a variable is a detected level of CO₂ and/or CO and/or NOₓ and/or particulate matter and/or hydrocarbon levels above or below predetermined threshold levels.

Optionally, the system comprises an air pollution and/or pollen detection module linked to a source of air pollution and/or pollen level information provided through the cloud/internet, wherein a trigger event is based on information thereby obtained.

Optionally, the sensor comprises an aircraft detection means and a variable is a geographical location of an aircraft above or below predetermined threshold distances.

Optionally, the aircraft detection means employs an Automatic dependent surveillance—broadcast (ADS-B) receiver.

Optionally, the aircraft detection means comprises an audio sensor adapted to detect noise level increases indicative of an approaching aircraft.

Optionally, the system comprises a radar based detection module linked to an online source of radar information provided through the internet, and wherein a trigger event is based on aircraft proximity and/or aircraft scheduling information thereby obtained.

Optionally, the system is controllable via a mobile computer device running suitable application software (“App”).

Optionally, the system further comprises a wireless remote control transmitting and receiving module for overriding the current mode of the pulley actuation mechanism and/or for reconfiguring trigger events.

Optionally, the system further comprises a manual operating switch which allows predetermined timings and/or sensed variables to be overridden.

According to a second aspect of the present invention there is provided a system for opening and closing a window aperture within a building, the system comprising:
(i) a moveable window panel;
(ii) an energiseable opening and/or closing mechanism; and
(iii) an aircraft detector for actively detecting aircraft noise and/or predicting when an aircraft will pass within a predetermined vicinity of the building and hence predicting a noise event;
   wherein the aircraft detector triggers a closing mode to the moveable window panel when aircraft noise is detected and/or when a noise event is predicted.

Optionally, the aircraft detector uses scheduling information and/or information concerning current and/or predicted geographic locations of aircraft obtained from the internet to predict when an aircraft will pass within a predetermined vicinity of the building.

Optionally, the aircraft detector comprises an audio sensor adapted to detect noise level increases indicative of an approaching aircraft.

Further features and advantages of the various aspects of the present invention will become apparent from the claims and the following description.

Embodiments of the present invention will now be described, by way of example only, with reference to the accompanying drawings, in which:—

FIG. 1 is a perspective illustration of a known prior art reciprocating window;

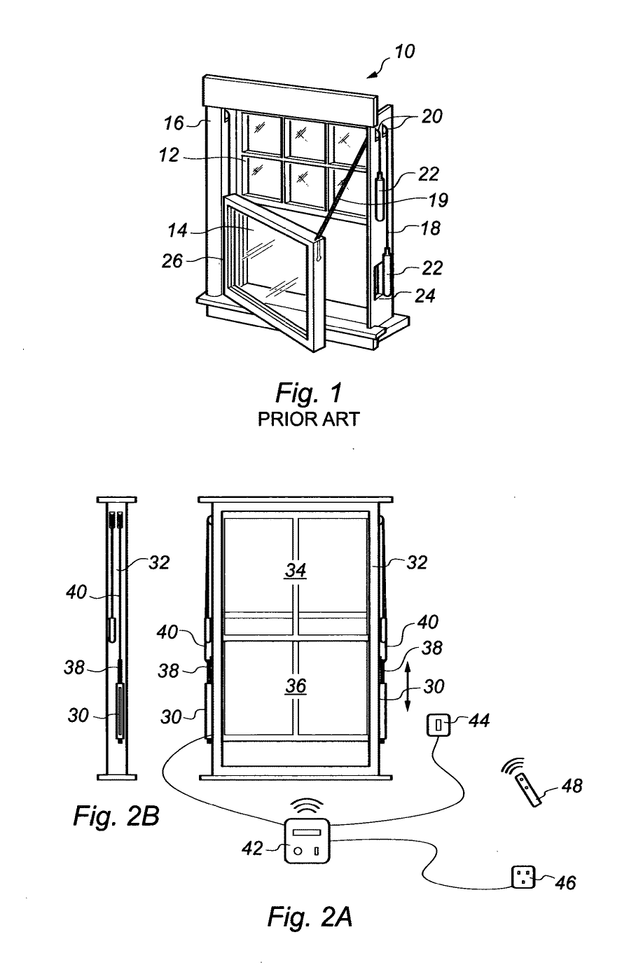

FIG. 2A is a schematic illustration of a system installed on a window where the window is illustrated in a partially opened configuration;

FIG. 2B is a partial cut-away side view of the window shown in FIG. 2A;

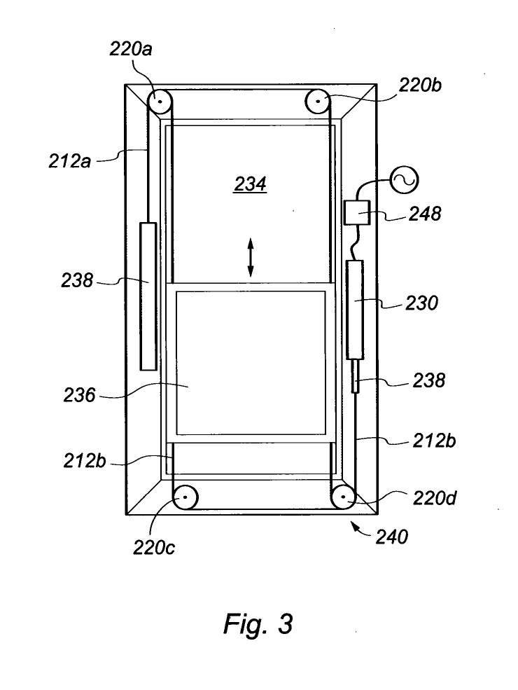

FIG. 3 is a schematic illustration of a system according to the present invention installed on a sash window where the window is illustrated in a partially opened configuration.

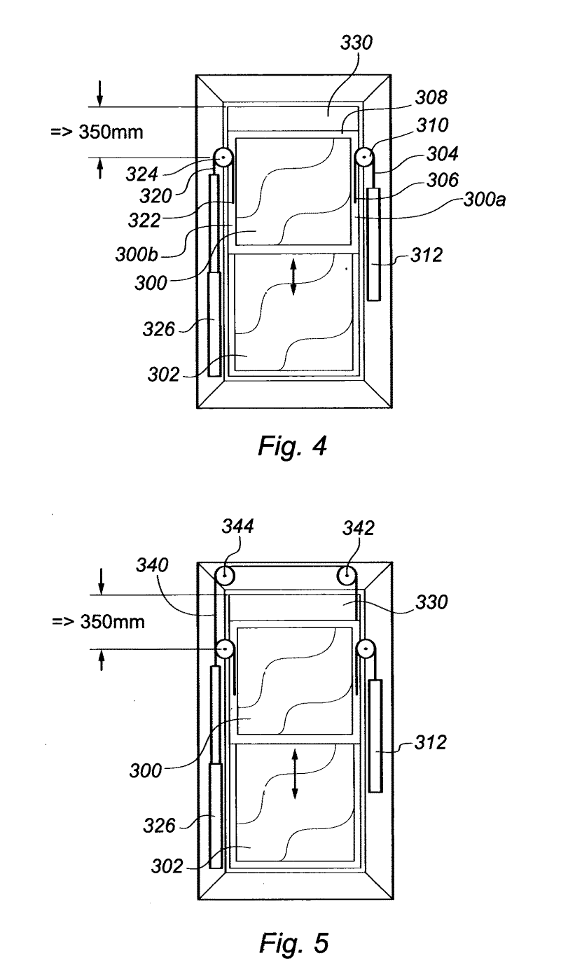

FIG. 4 is a schematic illustration of a first example of a system according to an aspect of the present invention;

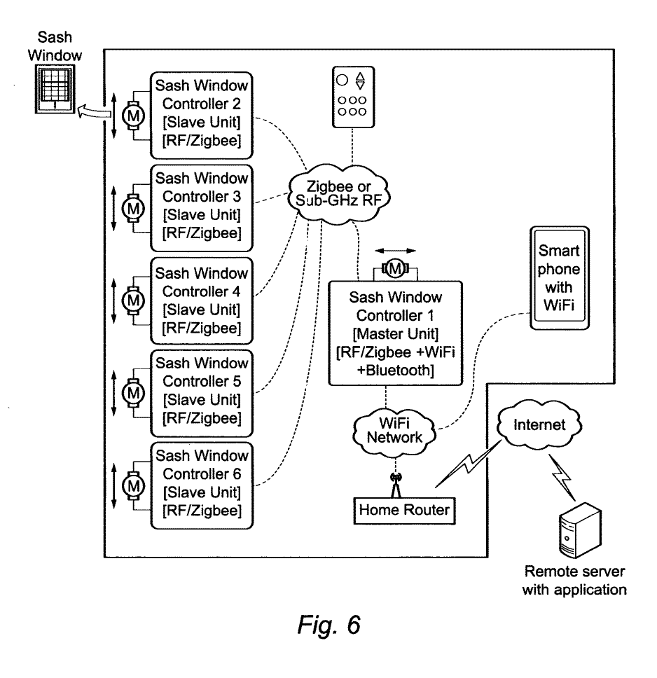

FIG. 5 is a schematic illustration of a second example of a system according to an aspect of the present invention;

FIG. 6 is a schematic illustration exemplifying a master-slave architecture for the system of the present invention.

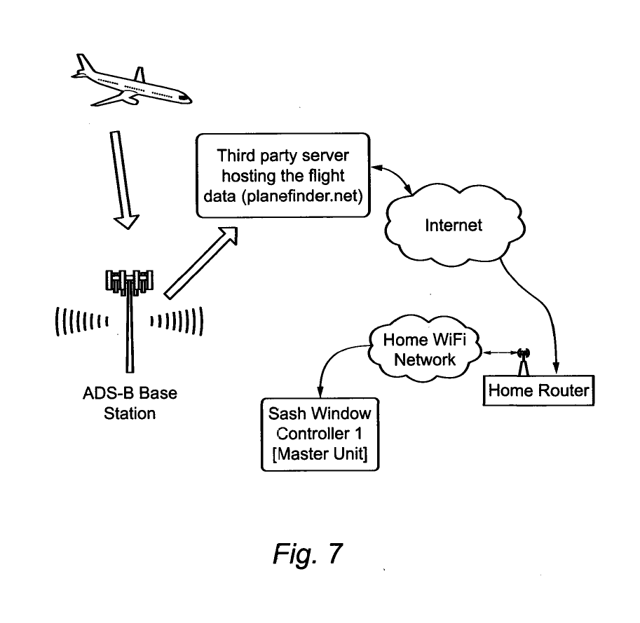

FIG. 7 is a schematic illustration showing the basic elements of an aircraft detection system in communication with a window system according to an aspect of the present invention.

With reference to FIG. 1, a typical prior art vertically reciprocating window arrangement 10 comprises an upper window panel 12 and a lower window panel 14 which are together mounted in sliding relationship with respect to one another in a window casing or frame 16 such that the upper and lower panels 12 and 14 are able to reciprocate up and down between closed and open configurations. In order to counterbalance the weight of the panels 12, 14 during movement between the open and closed configuration, an upper panel pulley cord 18 and a lower panel pulley cord 19 is provided on either side of the window. Each pulley cord is connected at one end to the window and at the other end to a weight 22 and pass over pulley wheels 20 provided toward the top of the window frame 16. An access panel 24 is typically also provided toward the bottom of the window frame 16. Furthermore, a hinge arrangement 26 is provided to allow the lower window panel 14 to hinge inwardly with respect to window fame 16 when desired for cleaning. It should be noted that the position indicated in FIG. 1 is a hinged maintenance position and the window would not normally assume this position during normal use.

With particular reference to FIGS. 2A and 2B, this discloses a system including window panel actuating mechanisms 30 on either side of a window casing or frame 32 which houses an upper window panel 34 and a lower window panel 36. The upper and lower window panels 34, 36 are mounted in such a way within the window frame 32 so as to allow reciprocating upwards and downwards sliding movement relative to one another.

Each actuating mechanism 30 comprises an electrically powered screw mechanism which is able to rotate a screw member 38 clockwise and anticlockwise in order to raise or lower the screw member 38 relative to the body of the actuating mechanism depending upon the direction of screw thread provided therebetween. The top of each screw member 38 is attached to one end of a pulley cord 40 and is provided with an anti-rotation means to avoid twisting of the pulley cords during use. A timer module 42 is electrically connected to the actuating mechanisms 30. A manual override switch 44 and a mains power supply 46 are also provided.

A wireless remote control device 48 is optionally provided and is capable of sending input and/or override control signals by means of a wireless link. An infra-red wireless link may be provided. Additionally or alternatively, other wireless links could be utilised such as a mobile computer, e.g. a smartphone or tablet, connected to the system via Wi-Fi or Bluetooth®. It is envisaged that the remote control device 48 may be capable of directly controlling the opening and closing motion of window panels on an individual and/or group basis; e.g. in its most basic sense the remote control device 48 could provide “up”, “down” and “close all” functionality. More advanced functionality may include the ability to reconfigure any pre-programmed opening and closing protocols stored in the timer module 42.

The disclosed system may be retrofitted to an existing reciprocating window arrangement. In this case, the actuation mechanisms 30 can be installed within an existing, or specially created, cavity of the window casing or frame 32. During installation of the actuation mechanism 30, the screw members 38 engaged with an end of the existing pulley cord 40 associated with the lower panel on either side of the window frame 32. A connecting wire is then run between each actuating mechanism 30 and the timer module 42 which itself is installed at an appropriate location nearby the window frame 32. Alternatively, the disclosed system may be integrated into a bespoke prefabricated window frame unit.

In use, a user programs the timer module 42 to open and/or close the window at predetermined times of day. The user may select these times by way of a manual input based on particular noise pollution and/or other events or may instead select a schedule from a number of pre-programmed routines. Alternatively, the timer module 42 may be internet enabled to allow it to control opening and closing of the window based on e.g. flight schedules or other predictable noise polluting events from an actively updated and managed online database which itself may be either user managed or managed by a service provider.

In addition, although not shown, a noise meter can also be mounted externally in order to allow the window to react to increases or decreases in noise levels.

In practice, when the user wishes to open e.g. the lower window panel 36 they may either do this by lifting it manually or alternatively by operating the manual override switch 44 until the lower panel 36 is in the desired open position. Achieving this by way of the manual override switch may be particularly preferable where the panels 34 and 36 are particularly heavy (e.g. where double or triple glazing is provided or where the panels 34, 36 are relatively large.).

As shown in FIGS. 2A and 2B, in this position, where the window is ajar, the screw members 38 reside in a partially retracted configuration within the actuation mechanisms 30 in order to retain the lower window panel 34 in the raised configuration by way of the pulley cord 40 attached thereto. This allows a user to, for example, retire to bed on a warm summer's evening with the window ajar in order to allow fresh air to circulate within a bedroom.

When a particular time of day arrives (for example, the early hours of the morning where the level of noise pollution from road traffic and/or passing aircraft is expected to increase) the timer module 42 will power the actuation mechanisms 30 in order to extend the screw members 38 from the actuation mechanisms 30, thereby allowing the weight of the lower window panel 34 to gradually close itself until it rests on the bottom of the window frame or sill in a fully closed position. In this way, any increase in noise pollution levels experienced by the user within the building will be minimised.

In a similar way, if the timer module 42 requires to open the lower window panel 34 after a period of expected increased noise pollution has passed, it can do so by, once again, retracting the screw members 38 into the actuation mechanism 30 to thereby open the window again. Indeed, it will be understood that the timer module 42 can be programmed to perform several such opening and closing actions in a single day depending upon the user's requirements.

The disclosed system is therefore able to open and close a reciprocating window in response to both expected time-based factors such as noise pollution, air pollution, pollen count etc. whilst ensuring that the maximum quantity of fresh air is allowed into the building over a given day. In addition, if desired, the system is able to actively and intelligently react to unexpected non-time based external factors by actively monitoring external factors, such as sound levels, and reacting accordingly.

With particular reference to FIG. 3, this discloses an alternative system for opening and closing a window aperture. The system comprises a window frame which houses an upper window panel 234 and a lower window panel 236. The upper and lower window panels 234, 236 are mounted in such a way within the window frame so as to allow upwards and downwards sliding movement relative to one another. A pulley assembly 240 is provided and comprises four pulley wheels 220a-d located proximate the four corners of the window frame 232. Two sets of pulley cords 212a, b extend from the upper and lower corners of the lower window panel 236 and extend around the pulley wheels 220a-d. At the left hand side of the window frame 232 both pulley cords 212a descend from pulley wheel 220a and terminate at a counterweight 238. At the right hand side of the window frame 232 both pulley cords 212b ascend from pulley wheel 220d and terminate at a pulley actuation mechanism 230. Importantly, the counterweight 238 is heavier than the lower window panel 236 thus imparting a continuous vertical opening force in the direction of the upper pulley wheels 220a, b.

The pulley actuation mechanism 230 is switchable, based on one or more trigger events, between a closing mode and an opening mode. When switched to its closing mode, the pulley actuation mechanism 230 imparts a closing force to the lower window panel 236—via the lower pulley cords 212b—to overcome its natural opening tendency. When switched to its opening mode, the pulley actuation mechanism 230 removes the closing force thus permitting the lower window panel 236 to rise by virtue of the counterweight 238 being heavier than the lower window panel 236.

In a non-limiting example, the pulley actuation mechanism 230 comprises an electrically powered screw mechanism of the type already described above with respect to FIGS. 2A and 2B. In particular, a screw member 238 is rotatable in one direction, e.g. clockwise, to retract it, i.e. in a direction away from pulley wheel 220d (thus imparting the closing force); and in the opposite direction, e.g. counter-clockwise, to extend it, i.e. towards pulley wheel 220d. The pulley cords 212b are each connected to the screw member 238 by means of an anti-rotation bearing to prevent their twisting during rotation of the screw member 238.

The trigger events used to switch the pulley actuation mechanism 230 between its opening and closing modes may include an elapsed period of time as calculated by a timer mechanism (not shown) forming part of the system and/or a variable detected by a sensor (not shown) forming part of the system. Variables detected by the sensor may include one or more those listed below in respect of the embodiments of FIGS. 4 and 5 and so, for the sake of brevity, need not be repeated here.

The system illustrated in FIG. 3 may be retrofitted to an existing reciprocating window arrangement whereby the pulley actuation mechanism 230 may be installed within an existing or specially created, cavity of the window frame 232 as described above with respect to the embodiment of FIGS. 2A and 2B.

In use, a user can employ pre-programmed routines which cause the timer mechanism(s) and/or sensor(s) to open and/or close the lower window panel 236 on the basis of predetermined trigger events. Alternatively, the user may override or reconfigure the pre-programmed routines as described above.

In practice, when a user wishes to open e.g. the lower window panel 236 they may either lift it manually, or alternatively by operating a manual override switch, or via a wireless remote control device, until the lower window panel 236 is in the desired open position. Achieving this in a non-manual manner may be particularly preferable where the panels 234 and 236 are particularly heavy (e.g. where double or triple glazing is provided or where the panels 234, 236 are relatively large).

A window may be provided with a powered opening and closing mechanism which is linked to aircraft detecting means for detecting whether an aircraft is passing or is likely to pass by, the building in which the window or door is installed. The window may be of the hinged, pivot, or sliding type.

FIG. 4 illustrates a window system in accordance with the present invention for opening and closing a window aperture. The system comprises a window casing or frame which houses an upper moveable window panel 300 and a lower fixed window panel 302. The upper and lower window panels cooperate with a pulley assembly within the window frame so as to facilitate upwards and downwards sliding movement of the moveable panel relative to the fixed window panel.

The pulley assembly comprises two separate parts. The first part includes a first pulley cord 304 attached at one end to a first lateral side 300a of the moveable panel at a point 306 remote from its uppermost edge 308. The first pulley cord 304 extends around a first pulley wheel 310 and its opposite end is connected to a counterweight 312 which imparts a first continuous closing force thereto. Both the first pulley wheel 310 and the counterweight 312 are mounted within the window casing or frame so as to be hidden from view. For the reasons discussed below, the moveable window panel 300 is heavier than the counterweight 312, i.e. the first continuous closing force imparted to the moveable window panel 300 by the counterweight 312 is insufficient by itself to actually raise the moveable window panel 300 to a closed position.

The second part of the pulley assembly includes a second pulley cord 320 attached at one end to a second lateral side 300b of the moveable panel 300 at a point 322 remote from its uppermost edge 308. The second pulley cord 320 extends around a second pulley wheel 324 and its opposite end is connected to a pulley actuation mechanism 326. Both the second pulley wheel 324 and the pulley actuation mechanism 326 are mounted within the vertical window casing or frame lying opposite from that which houses the first pulley wheel 310 and counterweight 312.

The pulley actuation mechanism 326 is switchable between energised (on) and non-energised (off) states based on one or more trigger events. When energised, the pulley actuation mechanism 326 retracts the second part of the pulley assembly thus imparting an additional closing force (i.e. additional to that continuously imparted by the counterweight 312) to the moveable panel 300 sufficient to raise the moveable panel into a closed position.

When non-energised, a passive opening force is imparted to the moveable panel 300 by virtue of its weight to lower the moveable panel into an open position to create an opening 330.

It will be appreciated that the pulley actuation mechanism is retro-fittable into a pre-existing window frame, i.e. it can be adapted so as to cooperate with pre-existing first and second pulley cords 304, 320 and pulley wheels 310, 324 associated with the upper panel 300 of a conventional manually operated sash and case window system.

FIG. 5 illustrates an alternative window system in accordance with the present invention for opening and closing a window aperture. The system of FIG. 5 shares many features of the system of FIG. 4 described above and so the equivalent features are not repeated. However, the additional features are as follows.

The pulley assembly of FIG. 5 comprises a further (third) separate part in addition to the separate first and second parts described above. The third part of the pulley assembly includes a third pulley cord 340 attached at one end to the first lateral side 300a of the moveable panel at a point proximate its uppermost edge 308. The third pulley cord 340 extends around third and fourth pulley wheels 342, 344 located within the upper lintel and its opposite end is also connected to the pulley actuation mechanism 326. Optionally, the second pulley wheel 324 may be arranged as a double pulley wheel and the third pulley cord 340 may also engage the second pulley wheel 324.

The second and fourth pulley wheels 324, 344 are arranged to be substantially aligned in the vertical direction and spaced by a distance which is at least 350 mm, and in any event no less than the full range or opening stroke of the moveable panel 300. The first and third pulley wheels 310, 342 are offset in the in the vertical direction and also spaced by a distance which is at least 350 mm, and in any event no less than the full range or opening stroke of the moveable panel 300.

In use, the natural passive state of the window systems of FIGS. 4 and 5 is for the moveable window panel 300 to be in an open condition. This is because the weight of the moveable panel 300 is greater than that of the counterweight 312, albeit preferably by no more than 10 kg. Therefore, if the pulley actuation mechanism 326 is in a passive or non-energised state, it does not impart any holding force on the second (or third) pulley cords 320 (340) such that the second (and third and fourth) pulley wheels 324 (342, 344) are all permitted to rotate clockwise under influence of the weight of the moveable panel 300 leaving an upper opening 330. The window system may be placed into its open condition based on one or more trigger events, as described below.

When different trigger events occur, the pulley actuation mechanism 326 is placed in an energised state whereby it selectively imparts a closing force on the second (or third) pulley cords 320 (340) such that the second (and third and fourth) pulley wheels 324 (342, 344) all rotate counter-clockwise and the moveable panel 300 is raised to close the upper opening 330. Though not shown in the drawings, the pulley actuation mechanism 326 may comprise an electrically powered screw mechanism of the type already described above with respect to FIGS. 2A, 2B and 3. It should be noted that when the pulley actuation mechanism 326 is in an active or energised state, the moveable panel 300 cannot be moved manually, i.e. it is effectively locked in position. Movement of the moveable panel 300 is only possible when the pulley actuation mechanism 326 is in a passive or non-energised state.

The trigger events used to switch the pulley actuation mechanism of FIGS. 4 and 5 between their opening and closing modes may include an elapsed period of time as calculated by a timer mechanism (not shown) and/or a variable detected by a sensor (not shown). Variables detected by a sensor may include one or more of the following:
(i) an external noise level above or below predetermined threshold levels as detected by a sound meter;
(ii) internal and/or external air temperature above or below predetermined threshold levels as detected by a thermometer;
(iii) a smoke level above or below predetermined threshold levels as detected by a smoke detector;
(iv) an external pollen count above or below predetermined threshold levels as detected by a pollen detector (or as obtained from an internet information source);
(v) CO₂ and/or CO and/or NOₓ and/or particulate matter and/or hydrocarbon levels above or below predetermined threshold levels as detected by an air quality detector (or as obtained from an internet information source, for example, http://www.londonair.org.uk);
(vi) geographical locations of aircraft above or below predetermined threshold distances as detected by an aircraft detection means (as obtained by radar, an ADS-B receiver, and audio sensor, or from an internet information source of flight schedules or real-time flight data); and
(vii) proximity of one or more users' mobile telephone beyond a predetermined threshold distance as calculated by mobile telephone location data.

The system illustrated in FIGS. 3, 4 and 5 may further comprise a wireless remote control device 248 for overriding the current mode of the pulley actuation mechanism 230 and/or for reconfiguring trigger events (e.g. altering upper and/or lower threshold levels as described above). The wireless remote control device 248 may employ an infra-red wireless link. Additionally or alternatively, other wireless links could be utilised such as a desktop and/or mobile computer (e.g. a smartphone or tablet computer) running suitable application software connected to the system via Wi-Fi or Bluetooth®. It is envisaged that the remote control device 248 may be capable of directly controlling the opening and closing motion of window or door panels on an individual and/or group basis; e.g. in its most basic sense the remote control device 48 could provide “up”, “down” and “close all” functionality which overrides any pre-programmed opening and closing protocols on a one-off basis. More advanced functionality may include the ability to reconfigure any pre-programmed opening and closing protocols by controlled by the timer module 42 and or sensor(s). The system may further comprise a manual operating switch which allows predetermined timings and/or sensed variables to be overridden or delayed.

The system illustrated in FIGS. 3, 4 and 5 may comprise a Sash Window Controller Unit (not shown) which will open or close the window at a pre-set time or with commends from a custom remote or smart phone application or a central server. The system may comprise different modules providing flexibility to a user for configuring window operation, i.e. open and close instructions. The different modules may include:
1. A Window Controller to operate the window;
2. A Remote to communicate with the Window Controller to operate the window;
3. A Smart phone application to configure/program and operate the Window Controller (Wi-fi or Bluetooth®);
4. A Central Server to configure/program and operate the Window Controller remotely (Wi-Fi).

With regard to module 1 above, this may operate on a Master & Slave basis as illustrated schematically in FIG. 6 where five window controller “slaves” and a remote controller are each paired with a “master” window controller which controls an entire group of individual windows based on command received from a remote server and smart phone.

This window controller system uses the ZigBee based wireless communication to interact within this group. The approximate total number of devices in the network is 7—of which 5 are slave window controllers, 1 master window controller and a remote controller. The master unit addresses each slave unit in the network with unique address to communicate and poll for the data and update the status/configuration. While the master unit communicates with server for configuration updates & real-time window operations, it can also operate a window similar to the slave unit.

The master slave communication topology has the advantage of not requiring all the window controllers (based on the number of windows per building/residence) communicating with a smart phone or remote server and this consequently reduces the number of devices using WiFi and therefore minimises the load on the home WiFi network which may have potential limitation for using other WiFi enabled devices. The key challenge in implementation of this topology is the co-existence of WiFi, Bluetooth & ZigBee wireless communication antennas routed & placed outside the window casing for the best performance. Interference with any neighbouring installations is mitigated by having a fixed unique network address (installation identification) for specific installations. This is a feature of Zigbee wireless communication technology.

FIG. 6 illustrates a system according to a further aspect of the present invention for opening and closing a window aperture within a building by means of an energisable opening and/or closing system for moving a moveable window panel. In is simplest form, an aircraft detector may actively detect aircraft noise and particularly noise level increases which are indicative of an approaching aircraft and exceed a predetermined threshold level. Alternatively, the aircraft detector may take the form of a local stand-alone radar receiving unit, such as a Mode S/ADS-B receiver unit.

However, the system illustrated in FIG. 6 (which may also be incorporated within the particular embodiments of FIGS. 2A, 2B, 3, 4 and 5) provides a more advanced solution which acquires aircraft data over the cloud/internet from, e.g. a third party server such as www.planefinder.net hosting flight data obtained from an automatic dependent surveillance—broadcast (ADS-B) receiver. The aircraft data may be downloaded from the third party server via the internet using an appropriate application program interface (API).

When it is determined that an aircraft is approaching within a predetermined vicinity of the building, a closing signal is communicated to the powered mechanism in order to close the window thereby reducing any noise pollution experienced by the occupant of the building. Once the detected aircraft has dissipated below a predetermined threshold level or the aircraft data confirms that the aircraft has exceeded a predetermined minimum distance from the building an opening signal is communicated to the powered mechanism in order to open the window.

It will be appreciated that the flight data obtained can be used to predict the arrival and departure times of aircraft and associated noise within a predetermined distance from a building. A window system incorporating such data will find particular application in domestic and commercial properties in close proximity to airports and aircraft flight paths.

Although particular embodiments of the invention have been disclosed herein in detail, this has been done by way of example and for the purposes of illustration only. The aforementioned embodiments are not intended to be limiting with respect to the scope of the appended claims. Features described in connection with any one embodiment may, unless the context dictates otherwise, be incorporated into any other embodiment.

It is contemplated by the inventors that various substitutions, alterations, and modifications may be made to the invention without departing from the scope of the invention as defined by the claims. Examples of these include the following:—

Although in certain embodiments an actuating mechanism is only shown to interact with the lower window panel, such mechanisms may be provided on either the lower window panel or the upper window panel (or both) as desired by the user.

The system of the first aspect may be installed on a window arrangement which reciprocates in a side-to-side nature rather than an upwards-and-downwards nature.

The various aspects and embodiments of the system can be integrated into a wired or wireless home automation network if desired. For example, the system may be programmed to operate with products such as Nest (https://nest.com); Homekit; Tado® (https://www.tado.com) and the like.

1. A system for opening and closing a window aperture, the system comprising:
a moveable window panel;
a pulley assembly coupled to the moveable window panel;
a counterweight; and
a pulley actuation mechanism;
wherein the moveable panel is heavier than the counterweight; the counterweight being attached to a first lateral side of the moveable panel via a first part of the pulley assembly to impart a first continuous closing force thereto; and the pulley actuation mechanism being attached to an opposite lateral side of the moveable panel via a second part of the pulley assembly; and wherein the pulley actuation mechanism is switchable between energised and non-energised states based on one or more trigger events, between:
a closing mode in which the pulley actuation mechanism retracts the second part of the pulley assembly thus imparting an additional closing force to the moveable panel sufficient to raise the moveable panel; and
an opening mode in which the pulley actuation mechanism is non-energised such that a passive opening force is imparted to the moveable panel by virtue of its weight to lower the moveable panel.

2. A system according to claim 1, wherein the first part of the pulley assembly comprises a first pulley cord, a first end of which is attached to a first lateral side of the moveable panel at a point remote from its uppermost edge; the pulley cord extending around a first pulley wheel and an opposite end thereof being connected to the counterweight.

3. A system according to claim 1 or 2, wherein the second part of the pulley assembly comprises a second pulley cord, a first end of which is attached to a second lateral side of the moveable panel at a point remote from its uppermost edge; the pulley cord extending around a second pulley wheel and an opposite end thereof being connected to the pulley actuation mechanism.

4. A system according to any preceding claim, wherein the pulley actuation mechanism is retro-fittable into a pre-existing window system and adapted to cooperate with pre-existing first and second pulley cords and pulley wheels.

5. A system according to any preceding claim, wherein the pulley assembly additionally comprises a third part comprising a third pulley cord, a first end of which is attached to the first lateral side of the moveable panel proximate its uppermost edge; the third pulley cord extending around third and fourth pulley wheels and an opposite end thereof being connected to the pulley actuation mechanism.

6. A system according to claim 5, wherein the third and fourth pulley wheels are located within the upper window lintel.

7. A system according to claim 5 or 6, wherein the second pulley wheel is a double pulley wheel that is substantially vertically aligned with the fourth pulley wheel.

8. A system according to any of claims 5 to 7, wherein the vertical spacing between the second and fourth pulley wheels is at least 350 mm, and no less than the opening stroke of the moveable panel.

9. A system according to any preceding claim, wherein the pulley actuation mechanism comprises a bi-directional screw thread mechanism for actively retracting, and passively releasing, lengths of pulley cord to raise and lower the moveable window panel.

10. A system according to any preceding claim, wherein the first and second pulley wheels are located within opposing side window casings.

11. A system according to any preceding claim, further comprising a timer mechanism wherein said one or more trigger events are based on predetermined time(s) as calculated by the timer mechanism.

12. A system according to claim 11, wherein the timer mechanism is adapted to retain a schedule of predetermined user-inputted timings based on a day, week, month and/or year schedule.

13. A system according to any preceding claim, further comprising a sensor, wherein one or more trigger events are based on a variable detected by the sensor.

14. A system according to claim 13, wherein the sensor comprises a sound meter and a variable is a detected external noise level above or below predetermined threshold levels.

15. A system according to claim 13 or 14, wherein the sensor comprises a thermometer and a variable is a detected internal and/or external air temperature above or below predetermined threshold levels.

16. A system according to any of claims 13 to 15, wherein the sensor comprises a smoke detector and a variable is a detected smoke level above or below predetermined threshold levels.

17. A system according to any of claims 13 to 16, wherein the sensor comprises a pollen detector and a variable is a detected external pollen count above or below predetermined threshold levels.

18. A system according to any of claims 13 to 17, wherein the sensor comprises an air quality detector and the variable is a detected level of CO₂ and/or CO and/or NOₓ and/or particulate matter and/or hydrocarbon levels above or below predetermined threshold levels.

19. A system according to claim 18 or 19, further comprising an air pollution and/or pollen detection module linked to a source of air pollution and/or pollen level information provided through the internet, and wherein a trigger event is based on information thereby obtained.

20. A system according to any of claims 13 to 19, wherein the sensor comprises an aircraft detection means and the variable is a geographical location of an aircraft above or below predetermined threshold distances.

21. A system according to claim 20, wherein the aircraft detection means employs an Automatic dependent surveillance—broadcast (ADS-B) receiver.

22. A system according to claim 20 or 21, wherein the aircraft detection means comprises an audio sensor adapted to detect noise level increases indicative of an approaching aircraft.

23. A system according to any of claims 20 to 22, further comprising a radar based detection module linked to an online source of radar information provided through the internet, and wherein a trigger event is based on aircraft proximity and/or aircraft scheduling information thereby obtained.

24. A system according to any preceding claim controllable via a mobile computer device running suitable application software (“App”).

25. A system according to any preceding claim, further comprising a wireless remote control transmitting and receiving module for overriding the current mode of the pulley actuation mechanism and/or for reconfiguring trigger events.

26. A system according to any preceding claim, further comprising a manual operating switch which allows predetermined timings and/or sensed variables to be overridden.

27. A system for opening and closing a window aperture within a building, the system comprising:
(i) a moveable window panel;
(ii) an energiseable opening and/or closing mechanism; and
(iii) an aircraft detector for actively detecting aircraft noise and/or predicting when an aircraft will pass within a predetermined vicinity of the building and hence predicting a noise event;
wherein the aircraft detector triggers a closing mode to the moveable window panel when aircraft noise is detected and/or when a noise event is predicted.

28. A system according to claim 27, wherein the aircraft detector uses aircraft scheduling information and/or information concerning current and/or predicted geographic locations of aircraft obtained from the internet to predict when an aircraft will pass within a predetermined vicinity of the building.

29. A system according to claim 27 or 28, wherein the aircraft detector comprises an audio sensor adapted to detect noise level increases indicative of an approaching aircraft.
